(19) United States
(12) Patent Application Publication
(10) Pub. No.: US 2007/0244650 A1
(43) Pub. Date: Oct. 18, 2007

(54) Service-oriented architecture for deploying, sharing, and using analytics

(76) Inventor: Francois Gauthier, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 11/732,707

(22) Filed: Apr. 3, 2007

Related U.S. Application Data
(60) Provisional application No. 60/789,239, filed on Apr. 3, 2006.

(51) Int. Cl. G06F 19/00; G06F 7/38

(52) U.S. Cl. 702/19; 708/445

(57) ABSTRACT

Methods, systems, and techniques for deploying, publishing, sharing, and using analytics are provided. Example embodiments provide a Analytic Server Computing System (an “ASCS”) which provides an SOA framework, for enabling users to develop and deploy analytics to their customers or other human or electronic clients by means of a web service/web server. Once published, such analytics can be consumed, for example, by a reporting interface for running analytics without having to understand the workings of the analytics. In one embodiment, the ASCS includes an analytic web service, which is used by consumers, typically through ASCS client code, to specify or discover analytics and to run them on consumer designated data and with designated parameter values. This abstract is provided to comply with rules requiring an abstract, and it is submitted with the intention that it will not be used to interpret or limit the scope or meaning of the claims.

### TECHNICAL FIELD

The present disclosure relates to methods and systems for providing analytics related services and, in particular, to improved methods and systems for deploying statistical analytics in an implementation independent manner using a service-oriented architecture.

### BACKGROUND

Statisticians in the course of their normal work develop a huge number of simple to very complex analytics (statistical analyses), sometimes targeted to particular communities of users and others to be used more generally. Consuming such analytics is often time-intensive and difficult, especially for clients, such as business users, who don't really understand the analytics but merely want to incorporate them for some other use, such as to create financial reports specific to their businesses. In addition, there are a plethora of different statistical languages in which such analytics may be created, leading to language specific tools for running such analytics. For example, a range of analytics can be developed, tested and examined using tools provided by S-PLUS®, a statistical programming language and environment provided by Insightful® Corporation. Other statistical programming languages or language packages, such as SPSS®, SAS® Software, Mathematica® and R, each provide their own corresponding development and execution environments.

In the S-PLUS® environment, traditional methods include solutions such as passing S-PLUS® generated data (the result of running such analytics) to spreadsheets, or other documents, which are made accessible from applications such as word processing and spreadsheet applications. Also, email is often used as a form to electronically transport this randomly organized information. Other solutions for sharing the information include posting documents to shared directories, or to a document management system. As a result, statisticians often complain of wasted time preparing documents for their clients who need to consume the results of their specific analyses. In addition, the results supplied to such clients of such statisticians are static—the clients cannot themselves rerun the analytics to test how different parameter values might influence the result. Thus, current models for using analytics deployed in business settings rely heavily on statisticians, not only to develop the analytics, but to run them and report the results in client-specific fashions to their communities of clients.

### BRIEF DESCRIPTION OF THE DRAWINGS

FIG. 1 is an example block diagram of components of an Analytics Server Computing System used in an example client-server environment to generate, publish, manage, share, or use analytics.

FIG. 2 is an example block diagram illustrating the interaction between various components or modules of an Analytics Server Computing System to run analytics interactively and on a scheduled basis.

FIG. 3 is an example sequence flow diagram of the interactions between example components of an Analytics Server Computing System to run an interactive analytic.

FIG. 4 is an example sequence flow diagram of the interactions between example components of an Analytics Server Computing System to run a scheduled analytic.

FIG. 5 is an example block diagram of a deployment architecture for storing analytics.

FIG. 6 is an example flow diagram illustrating an example process for determining an analytic responsive to a client request.

FIGS. 7A-7B are example screen displays of a user interface for an example analytic test client for deploying, testing, publishing, and managing analytics to be used with an example Analytics Server Computing System.

FIG. 8 is an example screen display of a user interface for an example dynamic reporting client that interfaces to an example Analytics Server Computing System to produce reports.

FIG. 9 is an example flow diagram illustrating an example process for running a report using an example Analytics Server Computing System.

FIG. 10 is an example flow diagram illustrating an example process for publishing a report using an example Analytics Server Computing System.

FIG. 11 is an example flow diagram illustrating an example process for displaying a report using an example Analytics Server Computing System.

FIGS. 12A-12C are example screen displays of a user interface for a client portal for managing the scheduling of reports.

FIG. 13 is an example flow diagram illustrating an example process for scheduling a report to be run by an example Analytics Server Computing System.

FIG. 14 is an example flow diagram illustrating example interactions performed by an example scheduling web service of an example Analytics Server Computing System to schedule a report.

FIG. 15 illustrates the contents of an example “.wsda” file.

FIG. 16 is an example flow diagram of an example process for running a chained analytic using an example Analytics Server Computing System.

FIG. 17 is an block diagram illustrating the generation and use of example inputs and outputs for chaining three analytics.

FIG. 18 is an example block diagram of a general purpose computer system for practicing embodiments of an Analytics Server Computing System.

FIG. 19 is an example block diagram of example technologies that may be used by components of an example Analytics Server Computing System to deploy analytics in a client-server environment.

FIG. 20 is a block diagram of an example configuration of components of an example Analytics Server Computing System to implement a secure client-server environment for deploying and using analytics.

FIG. 21 is an example sequence flow diagram of the interactions performed by example components of an Analytics Server Computing System to provide a function-based programmatic interface to run a designated analytic.

FIG. 22 is an example sequence flow diagram of the interactions performed by example components of an Analytics Server Computing System to provide a programmatic interface to dynamically discover and then run a designated analytic.

### DETAILED DESCRIPTION

Embodiments described herein provide enhanced computer- and network-based methods and systems for a service-oriented architecture (an “SOA”) that supports the deploying, publishing, sharing, and using of statistical based analysis tasks (analytics). As used herein, an analytic is the complete specification and definition of a particular task, which can organize data, perform statistical computations, and/or produce output data and/or graphics. Once published, such analytics can be consumed, for example, by a reporting interface such as supplied by a third party reporting service (e.g., in the form of a table, document, web portal, application, etc.), or, for example, by a business user wanting to run a particular analytic on varied sets of data or under differing assumptions without having to know anything about the statistical underpinnings or the language used to generate the analytic or even perhaps the workings of the analytic itself. Other uses are contemplated, and any client application or service that is capable of consuming XML Web pages or using an analytics application programming interface (“API”) as provided can be integrated into the environment described herein. Example embodiments provide an Analytic Server Computing System (an “ASCS”) which provides a Services-Oriented Architecture (“SOA”) framework, for enabling users (such as statisticians, or “quants”) to develop analytics and to deploy them to their customers or other human or electronic clients by means of a web service/web server.

The ASCS includes an analytic web service (“AWS”), which is used by consumers (typically through an ASCS client—code on the client side) to specify or discover analytics and to run them on consumer designated data and with designated parameter values, when an analytic supports various input parameters. In addition, the ASCS supports “chained” analytics—whereby a consumer can invoke one or more analytics (the same or different ones) in a row, using the results of one to influence the input to the next analytic downstream.

In overview of the process, a consumer of an analytic sends a request to the analytic web service through the ASCS client, the request specifying the data to be analyzed and the analytic to be performed. The analytic web service then responds with the “answer” from the called analytic, whose format depends upon the definition of the analytic. In a typical scenario, the analytic web service (or other component of the ASCS) responds with an indication of where the result data can be found. That way, the consumer (e.g., any client that wishes to consume the data, human or electronic) can use a variety of tools and or reporting interfaces to access the actual result data. For example, an ASCS client may be code that is embedded into a reporting service that presents the result data in a spreadsheet format. Alternatively, in other embodiments, the ASCS may return the result data directly to the requesting consumer as a series of XML strings. In some embodiments of the ASCS, the result data may be stored in a content management system (“CMS”), which may provide search and filtering support as well as access management. By conducting the performance of analytics in this manner, the analytic specification—response paradigm hides the particulars of the analytic from the end consumer, such as a business user, including even the language in which the analytic is developed. In some embodiments, the ASCS is configured to interface to a plurality of different statistical language engines, including for example, S-PLUS, R, SAS, SPSS, Matlab, Mathematica, etc.

One example embodiment, described in detail below, provides an Analytic Server Computing System targeted for the S-PLUS or I-Miner environment and the S-PLUS/I-Miner analytic developer. Other embodiments targeted for other language environments can be similarly specified and implemented. In the described S-PLUS environment, a statistician creates an analytic using the standard S-PLUS Workbench and deploys the created analytic via a “portal” that is used by the ASCS to share analytics. In some embodiments, a “publish” function is provided by the Workbench, which automatically stores the analytic and associated parameter and run information in appropriate storage.

Although the techniques of running analytics and the Analytics Server Computing System are generally applicable to any type of analytic code, program, or module, the phrase “analytic,” “statistical program,” etc. is used generally to imply any type of code and data organized for performing statistical or analytic analysis. Also, although the examples described herein often refer to a business user, corporate web portal, etc., the techniques described herein can also be used by any type of user or computing system desiring to incorporate or interface to analytics. In addition, the concepts and techniques described to generate, publish, manage, share, or use analytics also may be useful to create a variety of other systems and interfaces to analytics and similar programs that consumers may wish to call without knowing a whole lot about them. For example, similar techniques may be used to interface to different types of simulation and modeling programs as well as GRID computing nodes and other high performance computing platforms.

Also, although certain terms are used primarily herein, other terms could be used interchangeably to yield equivalent embodiments and examples. For example, it is well-known that equivalent terms in the statistics field and in other similar fields could be substituted for such terms as “parameter” etc. In addition, terms may have alternate spellings which may or may not be explicitly mentioned, and all such variations of terms are intended to be included.

In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the code or sequence flow, different code or sequence flows, etc. Thus, the scope of the techniques and/or functions described are not limited by the particular order, selection, or decomposition of steps described with reference to any particular routine or sequence diagram. Note as well that conventions utilized in sequence diagrams (such as whether a message is conveyed as synchronous or not) may or may not have significance, and, in any case, equivalents not shown are contemplated.

In one example embodiment, the Analytics Server Computing System comprises one or more functional components/modules that work together to support service-oriented deployment, publishing, management, and invocation of analytics. In one embodiment, the Analytics Server Computing System comprises one or more functional components/modules that work together to deploy, publish, manage, share, and use or otherwise incorporate analytics in a language independent manner. These components may be implemented in software or hardware or a combination of both.

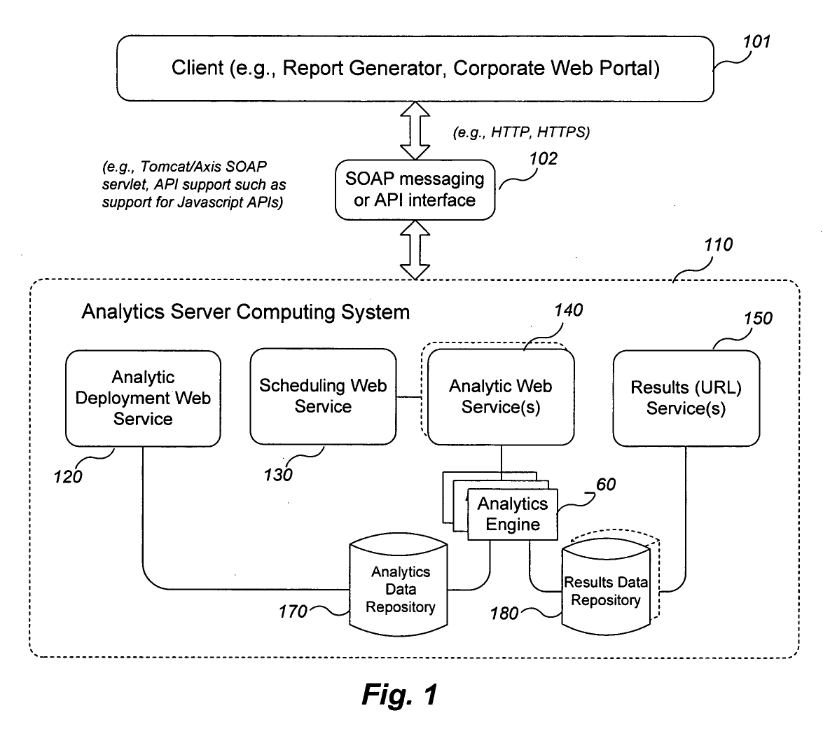

FIG. 1 is an example block diagram of components/modules of an Analytics Server Computing System used in an example client-server environment to generate, publish, manage, share, or use analytics. For example, a business user may use an Analytics Server Computing System (“ASCS”) to run a report that invokes one of the analytics deployed to the ASCS by a statistician. In FIG. 1, an Analytics Server Computing System 110 comprises an Analytics Deployment Web Server 120, a scheduling web service 130, an analytic web service 140, and a results (URL) service 150. The ASCS 110 communicates with clients 101 (e.g., a report generator/service/serve, a corporate web portal, an analytic test portal, etc.) through a messaging interface 102, for example using SOAP or a set of analytics APIs (e.g., written in JavaScript) designed to hide the details of the messaging interface. The analytic deployment web service 120 (“ADWS”) is used, for example, by analytic developers to make analytics sharable to a set of authorized users, for example, by storing them in one or more analytics data repositories 179. It is also used to update and manage analytics. The analytic web service 140 (“AWS”) is the “workhorse” that provides to clients such as client 101 a language and system independent interface to the available analytics. Based upon a request received by the AWS 140, it invokes one or more analytic engines 160 to run the requested analytic(s). As will be described further below, the AWS provides both the ability to call a specific analytic through its “functional analytic API” and the ability to discover available (e.g., deployed and authorized) analytics through its “dynamic discovery analytic APIs” and then to call one of the discovered selected analytic. As well, a client may also invoke the analytic web services using the underlying message protocols (e.g., SOAP) as well. Each analytic engine 160 retrieves a designated analytic from one or more analytics data repositories 170 and, after running the analytic, stores the results in one or more results data repositories 180. The results (URL) service 150 may deliver a uniform resource locator (“URL” or “URI”) to the requesting client when the results are available, which points to the results available through the results data repository 180. This approach allows a client module (such as a web browser) to create web pages with embedded tags that refer to the result files, whose contents are only uploaded to the client at viewing time. The delivery of a results URL may occur synchronously or asynchronously depending upon the scenario. Also, in some embodiments, the results (URL) service 150 interfaces to or is implemented using a content management system. The scheduling web service 130 (“SWS”) provides mechanisms for running deployed analytics at deferred times, for example, at a prescribed time, on a particular day, month, year, etc., between a specified range of times, or recurring according to any such specification. The scheduling web service 130 invokes the analytic web service 140 to run the designated analytic when a scheduled event is triggered.

In one embodiment, the messaging interface 102 is provided using a Tomcat/Axis combination SOAP servlet, to transform requests between XML and Java. Other messaging support could be used. Also, access to all of the component web services of an ASCS 110 is performed typically using HTTP, or HTTPS. This allows access to either the web services or the analytic results to be subjected to secure authentication protocols. Also, substitutions for the various messages and protocols are contemplated and can be integrated with the modules/components described. Also, although the components/modules of the ASCS are shown in one “box,” it is not intended that they all co-reside on a single server. They may be distributed, clustered, and managed by another clustering service such as a load balancing service.

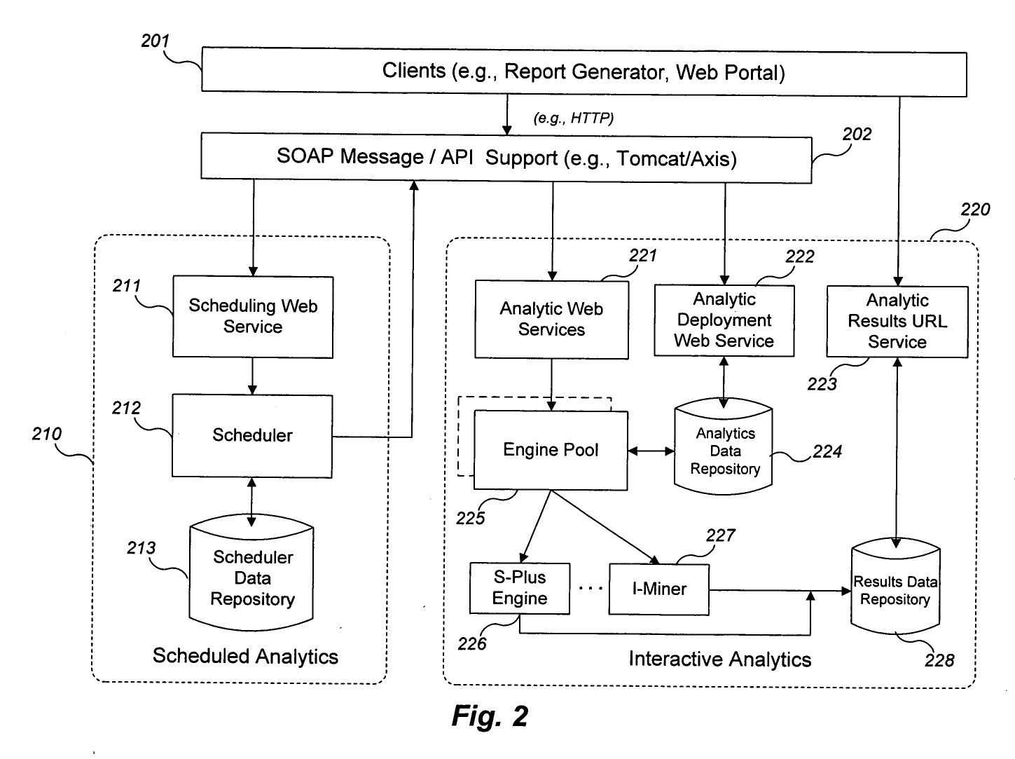

The ASCS is intended to be ultimately used by consumers such as business users to run analytics. As mentioned, analytics may be run interactively using the analytic web service 140 directly or on a scheduled basis, by invoking the analytic scheduling service 140. FIG. 2 is an example block diagram illustrating the interaction between various components or modules of an Analytics Server Computing System to run analytics interactively and on a scheduled basis. Note that, although not explicitly shown, any of these components may be implemented as one or more of them. In FIG. 2, the Analytics Server Computing System is shown with its components organized according to their use for running scheduled or interactive analytics.

In particular, scheduled analytics 210 are performed by a client 201 making a request through analytics API/messaging interface 202 to the scheduling web service 211. The scheduling web service 211 schedules an analytic run event with the scheduler 212, which stores all of the information concerning the event in a scheduler data repository 213, including for example, an indication of the analytic to be run, the parameters, and any associated parameter values. When the event triggers, the scheduler 212 retrieves the event record from the scheduler data repository 213 and calls the analytic web services 221 through the analytics API/messaging interface 202. The flow of the scheduled analytic through the other components of the ASCS is similar to how the ASCS handles interactive analytics.

Once a request to run an analytic is received by the analytic web services 221, the AWS determines an analytic engine to invoke, typically by requesting an appropriate engine from engine pool 225. (As mentioned, the analytic web services 221 also supports an interface for a client to discover what analytics are available, before requesting a particular analytic to be run.) Engine pool 225 may include load balancing support to assist in choosing an appropriate engine. Engine pool 225 then retrieves any meta-data and the designated analytic from an analytics data repository 224, and then invokes the determined engine, for example, one of the S-PLUS engines 226, an I-Miner engine 227 or other engine, to run the designated analytic. Note that the ASCS provides a uniform interface to clients regardless of the particular engine used to perform the analytic. The engine 226, 227 stores any results in the results data repository 228, and the analytic web service returns an indication to these results typically as a URL. Note that in other embodiments, an indication may be returned that is specific to the CMS or results repository in use. The results of the run analytic are then made available to a client through the Analytic results (URL) service 223.

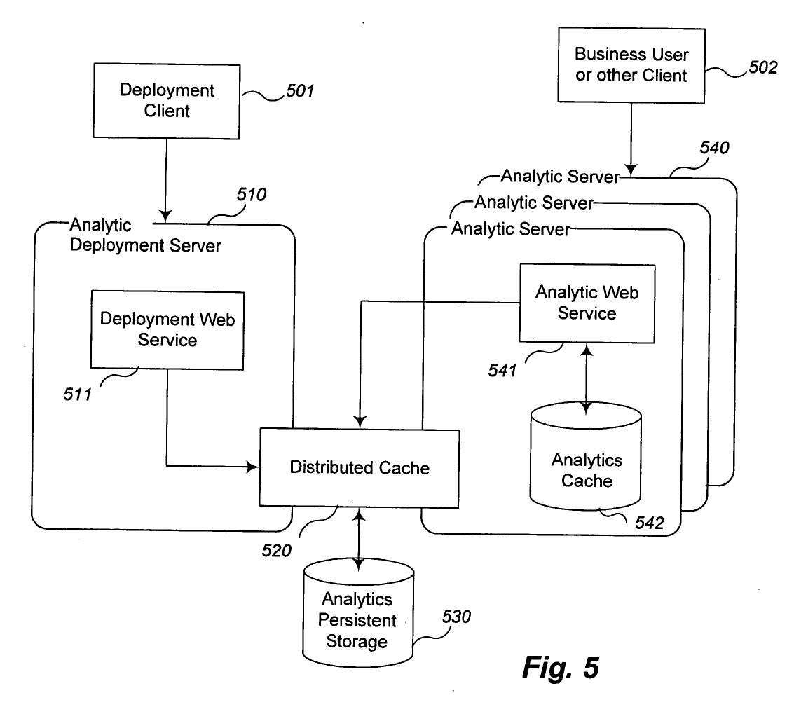

When a user (such as a statistician) wishes to deploy an analytic, the user through an ASCS client 201 and the analytics API/messaging interface 202 invokes the analytic deployment web service 222 to store the analytic and any associated meta-data in the analytics data repository 224. Typically, the user engages standard tools for defining scripts, programs and modules in the language of choice to develop and deploy the analytic. In one embodiment, all of the files needed to deploy an analytic are packaged into a single file (such as a “ZIP” file) by the language environment (e.g., S-PLUS Workbench) and downloaded as appropriate into the repository 224. As discussed below with respect to FIG. 5, the analytics may be deployed to a persistent store yet cached, either locally or distributed, or both. In addition, techniques for authentication and authorization may be incorporated in standard or proprietary ways to control both the deployment of analytics and their access.

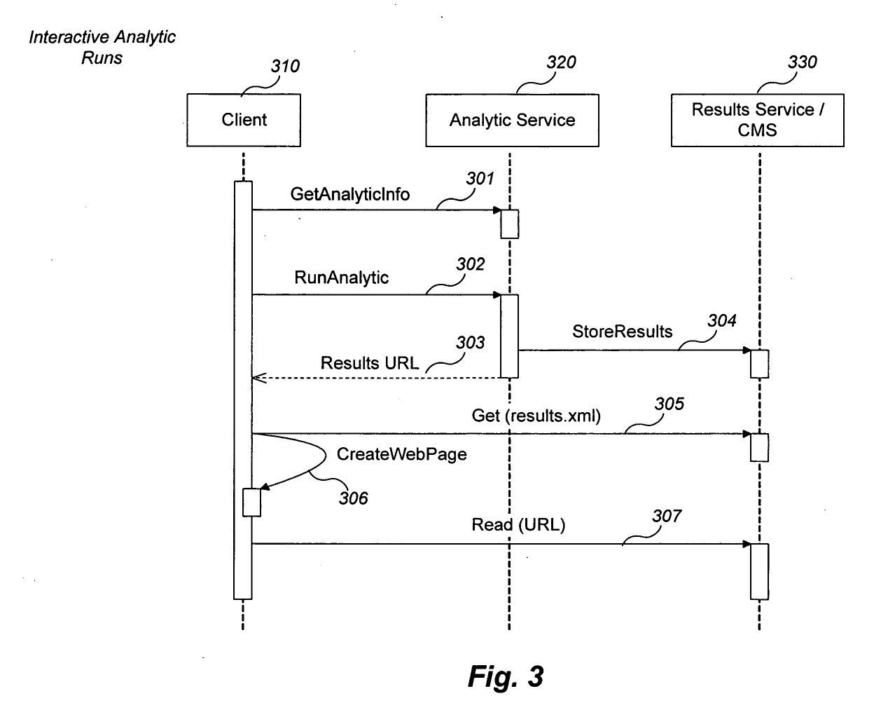

FIG. 3 is an example sequence flow diagram of the interactions between example components of an Analytics Server Computing System to run an interactive analytic. The diagram shows a communication sequence between three components, the client 310, an analytic web service 320, and a results service/CMS 330 to run an analytic interactively. In this instance, the client 310 first invokes GetAnalyticInfo in communication 301 to request a list of currently available analytics. Using a returned list, the client 310 then invokes RunAnalytic in communication 302 to designate a particular analytic to be run, along with desired values for available parameters. The analytic web service 320 then causes the analytic to be run (for example, as described above with reference to FIG. 2) and invokes StoreResults in communication 304 to request the Result Service/CMS 330 to store the results appropriately. The AWS 320 then returns a URL in communication 303, which the client 310 may then use to retrieve the results on an as needed basis. In particular, client 310 in communication 305 may request the results using Get(results.xml), which returns them (in one embodiment) as an XML file (in results.xml) that includes further links (URLs) to the actual data. The client 310 can then render a web page using this XML file, and when desired, resolve the links via Read communication 307 to obtain the actual data to display to the user.

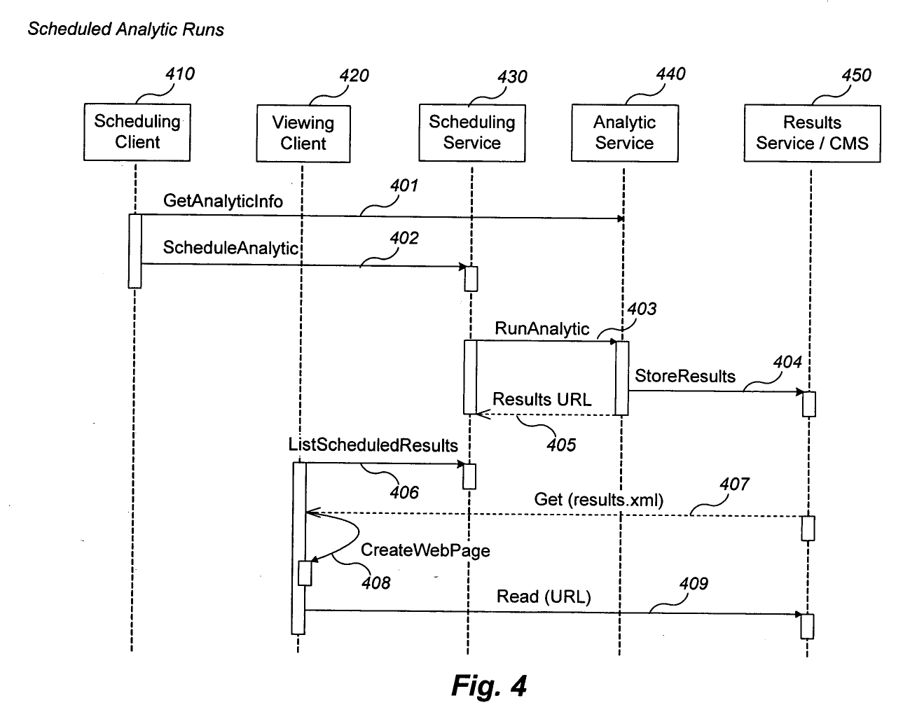

FIG. 4 is an example sequence flow diagram of the interactions between example components of an Analytics Server Computing System to run a scheduled analytic. The diagram shows a communication sequence between five components, the scheduling client 410, a viewing client 420, a scheduling web service 430, an analytic web service 440, and a results service/CMS 450 to schedule an analytic to be run. It shares several of the communications with FIG. 3. In particular, in response to using communication 401 GetAnalyticInfo to discover the analytics available, the scheduling client 410 then calls ScheduleAnalytic in communication 402 to request the scheduling web service 430 to schedule a deferred run of the designated analytic. Once the scheduled event triggers, the Scheduling Service 430 interacts with the analytic web service 440 and the results service/CMS 450 as did the client 310 in FIG. 3. The viewing client 420 can then inquire of the Scheduling Service 430 using ListScheduledResults communication 406 on the status of particular scheduled runs. Once noted that an analytic run has completed, and thus has associated results, the viewing client 420 can then request the results using communications) 407-409 in a similar manner to communications 305-309 in FIG. 3.

As mentioned with respect to the above figures, an analytic web server (such as AWS 140 in FIG. 1) on its own or through the assistance of an engine pool (such as engine pool 225 in FIG. 2) determines the correct analytic to run and the location of the analytic and any associated metadata when a designated analytic is requested to be run. The actions performed by such a service are influenced by the mechanism used to deploy analytics. In one embodiment, the analytic deployment web service stores analytics in a persistent data repository, which is further cached locally for each analytic web server and potentially also distributed via a distributed cache mechanism.

FIG. 5 is an example block diagram of a deployment architecture for storing analytics. This architecture shows the persistent storage of analytics begin further communicating by means of a distributed cache, which is used to update the local caches of each analytic web server. In particular, a deployment client application 501 invokes a deployment web service 511 of an Analytic Deployment Server 510 to deploy a designated analytic to a distributed cache 520. The distributed cache 520 updates analytics persistent storage 530 as needed. When a request, for example, from a business user or other client 502 comes into an analytic web server 540, the analytic web service 540 thereupon looks in a local cache 542 to first locate the designated analytic, and, if not found, retrieves it from the distributed cache 520.

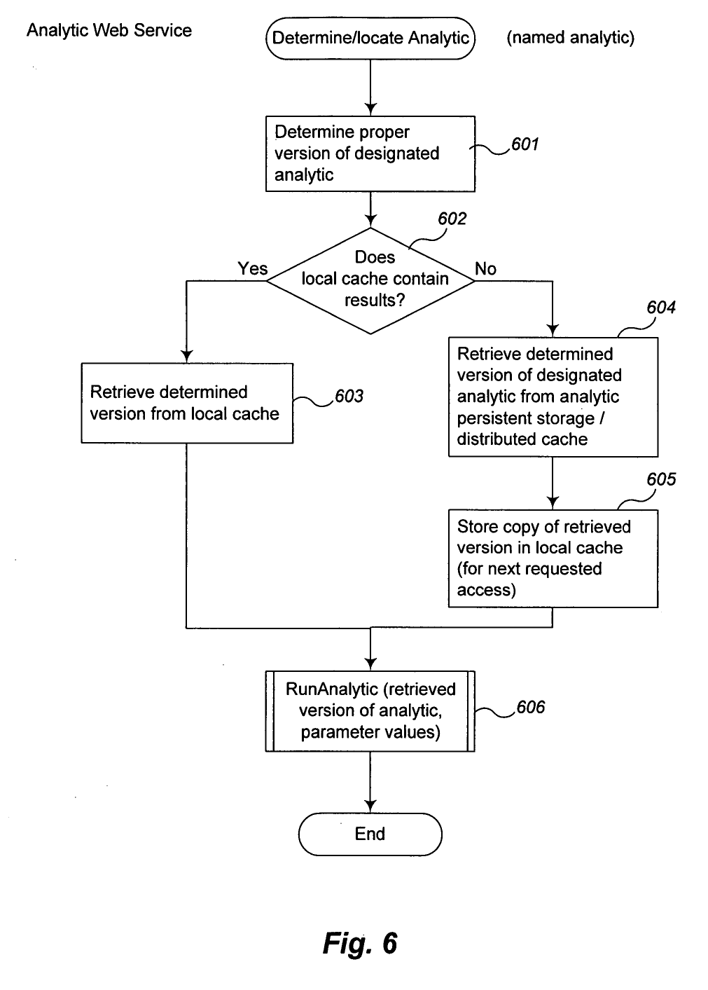

FIG. 6 is an example flow diagram illustrating an example process for determining an analytic responsive to a client request. This process may be performed, for example, by an analytic web service of an example Analytics Server Computing System. For example, an analytic web service 540 may invoke the routine of FIG. 6 to locate an analytic designated by client 502. In step 601, the routine determines the proper “version” that corresponds to the designated analytic. For example, an analytic having multiple versions may have been deployed by a statistician, only one of which corresponds to the actual client request. In step 602, the routine determines whether the proper version of the analytic is available in the local cache associated with the analytic web server and, if so, continues in step 603 to retrieve the determined version from the local cache, otherwise continues in step 604. In step 604, the routine retrieves the determined version of the designated analytic from the distributed cache, if it exists there, otherwise, the distributed cache updates itself to retrieve the proper version which it then returns. In step 605, the routine stores a copy of the retrieved analytic locally, so that the next request will likely find it in the local cache. In step 606, the routine calls the RunAnalytic communication designating the retrieved analytic and associated parameter values, and then ends. (In other embodiments, the routine may return an indication of the analytic to be run and let the calling routine perform the analytic run.)

As mentioned previously, many different clients for interacting with an example Analytics Server Computing System can be envisioned. In one embodiment, the ASCS is distributed with a test client to test, deploy, and manage analytics; a reporting client to generate reports from report templates which cause analytics to be run according to the mechanisms described thus far; and a reports management (web portal) interface for scheduling already existing report templates to be run as reports. These clients may attract different types of user with differing skills to use the ASCS.

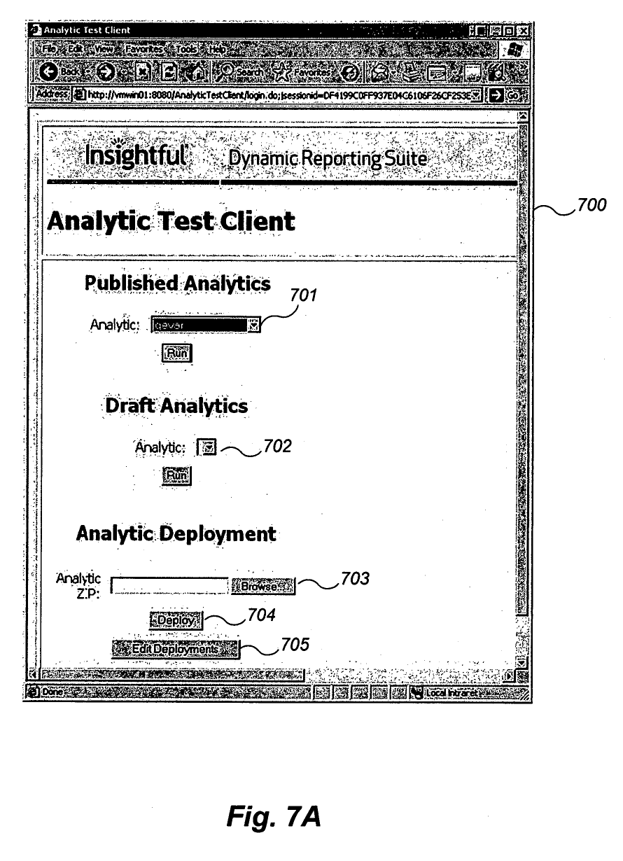

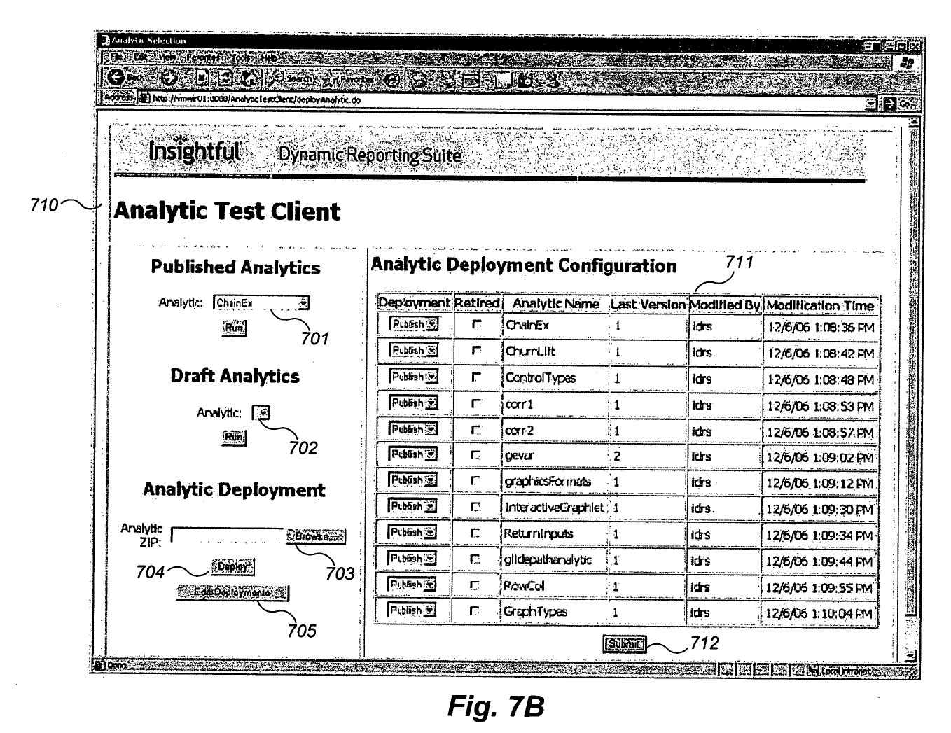

FIGS. 7A-7B are example screen displays of a user interface for an example analytic test client for deploying, testing, publishing, and managing analytics to be used with an example Analytics Server Computing System. Other interfaces can of course be incorporated to deploy analytics. The main display screen 700 of the test client presents a user interface control 701 to choose a published analytic to run; a user interface control 702 to choose a draft (not yet published) analytic to run; and a user interface control 703 to deploy using button 704 a “zipped” (e.g., a compressed archive) package 703 containing an analytic and associated metadata using, for example, an analytic deployment web service. In addition, the test client user may select an edit deployments button 705 to edit the set of analytics already deployed that the user has authorization to edit.

FIG. 7B shows a test client screen display after selection of the edit deployments button 705. In particular, each of the analytics that the user can edit is shown in configuration table 711, which provides an interface to change the status of a designated analytic (for example, from “draft” to “deployed”) as well as to retire (e.g., delete from availability) a designated analytic. Once any modifications are completed, the user can select the submit button 712 to make any indicated changes effective.

A typical interface for a reporting client configured to produce reports that use analytics, such as provided using Insightful® Corporation's Dynamic Reporting Suite (“IDRS”), communicates with an Analytic Server Computing System to perform operations such as running a report, publishing a report, displaying a report, and scheduling a report.

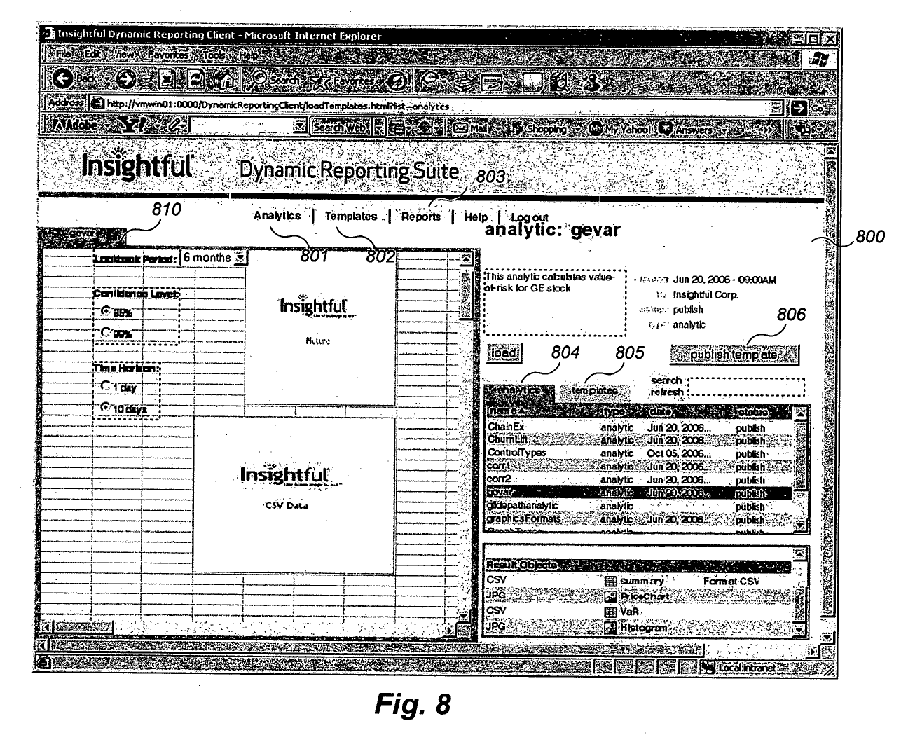

FIG. 8 is an example screen display of a user interface for an example dynamic reporting client that interfaces to an example Analytics Server Computing System to produce reports. The example shown in FIG. 8 is from Insightful® Corporation's Dynamic Reporting Suite software. As shown, the client interface 800 allows users to run particular analytics via link 801; to retrieve, edit, and manage templates for defining reports via link 802; to run already populated reports (e.g., with analytics) via link 803; and to perform other commands. Although this interface is shown via a web browser, other types of applications, modules, and interfaces may be used to present similar information. Screen display 800 is shown with a particular page of an analytic “gevar” shown as selected from tab control 804. The particular variables and output for this analytic are illustrated on view 810, which shows a couple of variable that can be defined (e.g., confidence level and time horizon) and the sort of output (pictures) that are created with the analytic is run. This information allows a report template designer to lay out the appropriate fields intelligently.

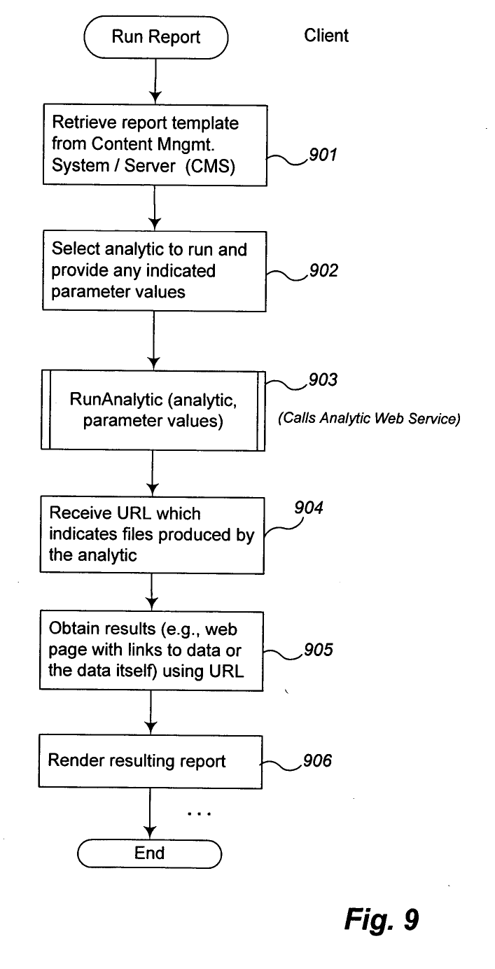

FIG. 9 is an example flow diagram illustrating an example process for running a report using an example Analytics Server Computing System. This routine may be performed, for example, by a dynamic reporting client module or an example analytic test client module. In step 901, the client first retrieves a report template from storage, such as from a content management system. Using a CMS is beneficial because a consumer can use the search and filtering capabilities of the CMS to locate the desired report template more easily. In step 902, the client module selects the analytic to run (for example, by receiving input from a business user), and provides indications of any desired parameter values. In step 903, the client module invokes the communication RunAnalytic designating the particular analytic to run and the parameter values. This communication results in a call to an analytic web service, which in turn calls an engine to perform the analytic. In step 904, the client module receives a URL which points to result files produced by running the analytic. In step 905, the module obtains the results, for example, by requesting a web page with links to the data or by requesting the data itself. In step 906, the client module renders the result report (for example, a web page), resolving any references to “real” data as needed, performing other processing if needed, and ends.

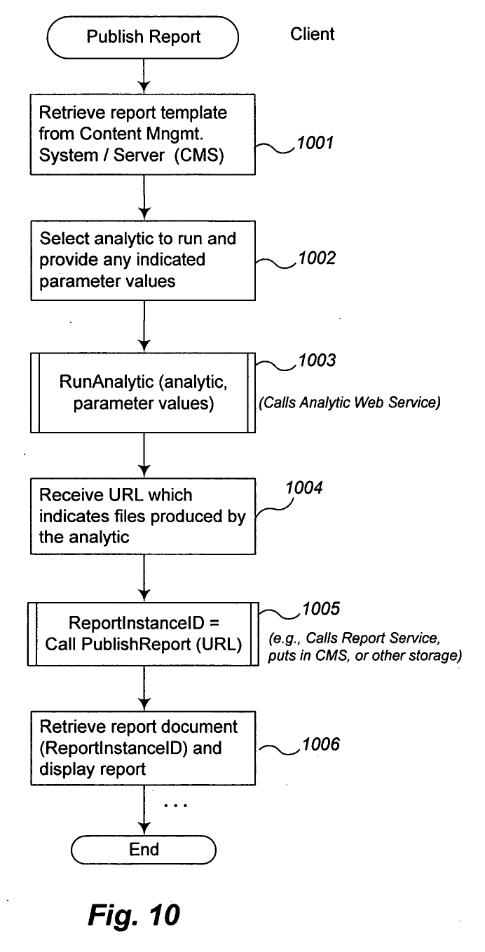

Once a report has been generated by a user, the user may wish to “publish” the report so that other consumers can use it as well. A report is in one sense a particular instance or running a report template with one or more designated analytics and associated parameter values. FIG. 10 is an example flow diagram illustrating an example process for publishing a report using an example Analytics Server Computing System. Steps 1001-1004 are similar to steps 901-904 in FIG. 9. In step 1005, the client module communicates with the reporting service/CMS to publish the (executed) report. It passes to the reporting service the URL returned from running the report, and keeps an identifier reference to the published report. In step 1006, the client module retrieves a report document using the identifier reference and displays the retrieved report, and ends. Other processing steps after publishing a report can be similarly envisioned and implemented.

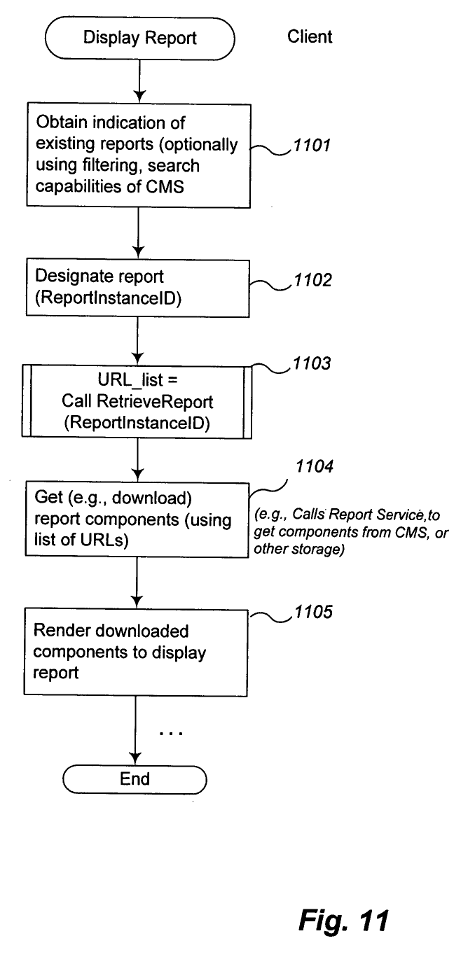

FIG. 11 is an example flow diagram illustrating an example process for displaying a report using an example Analytics Server Computing System. Such a routine may be invoked, for example, to display a report that was generated interactively, or that was run as a scheduled job. In step 1101, the client module, obtains an indication of the existing reports that may be displayed. In one embodiment, this step invokes the capabilities of a CMS to search for reports and provide filtering as desired. In step 1102, the client module designates one of the indicated reports and retrieves its identifier. Then, in step 1103, the client module calls a server, for example, a reporting server, to retrieve the report identified by the retrieved identifier. In one embodiment, the reporting server returns a list of URLs, which can be later resolved to access the actual report data/components. For example, in step 1104, the client module performs an HTTP “Get” operation to retrieve the report components using the list of URLs obtained in step 1103. These components may be stored, for example, in a results data repository managed by a CMS. In step 1105, the client module renders the downloaded components to present the report, performs other processing as needed, and ends.

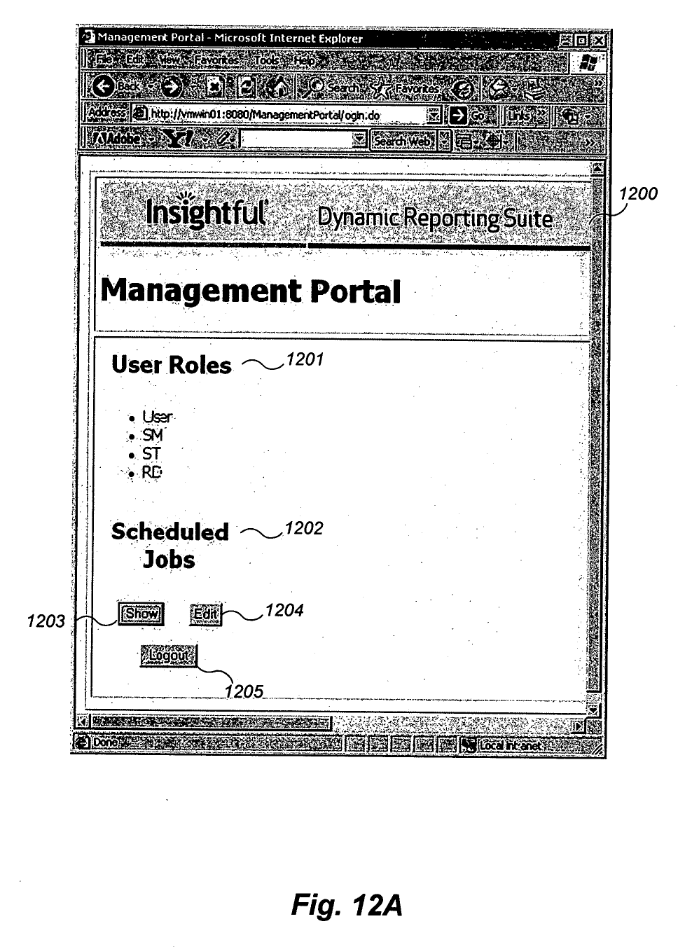

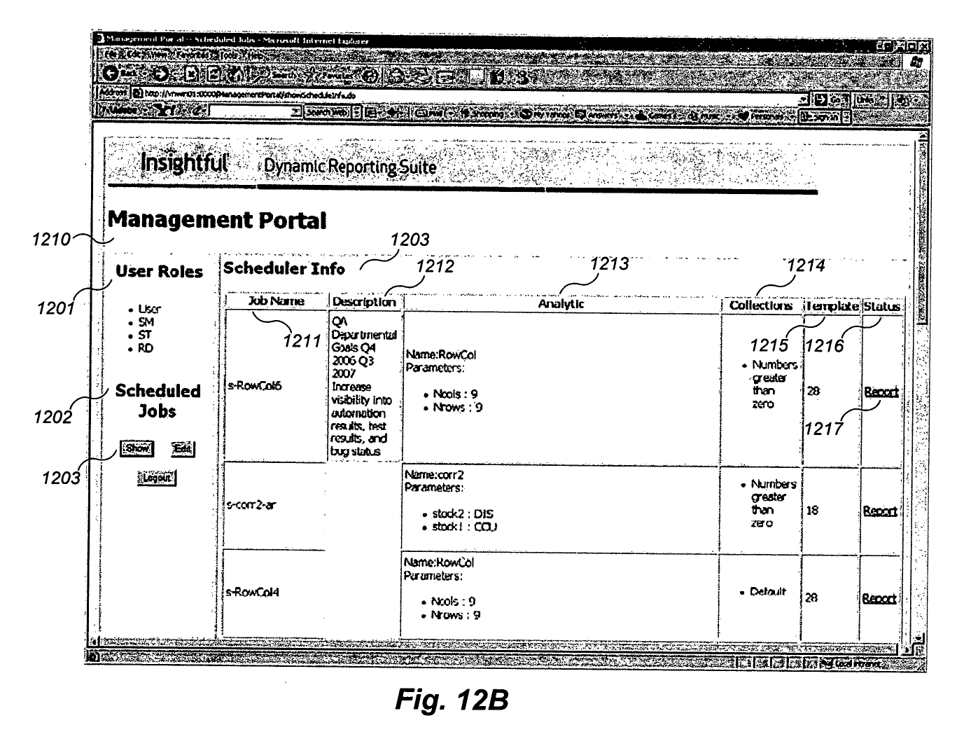

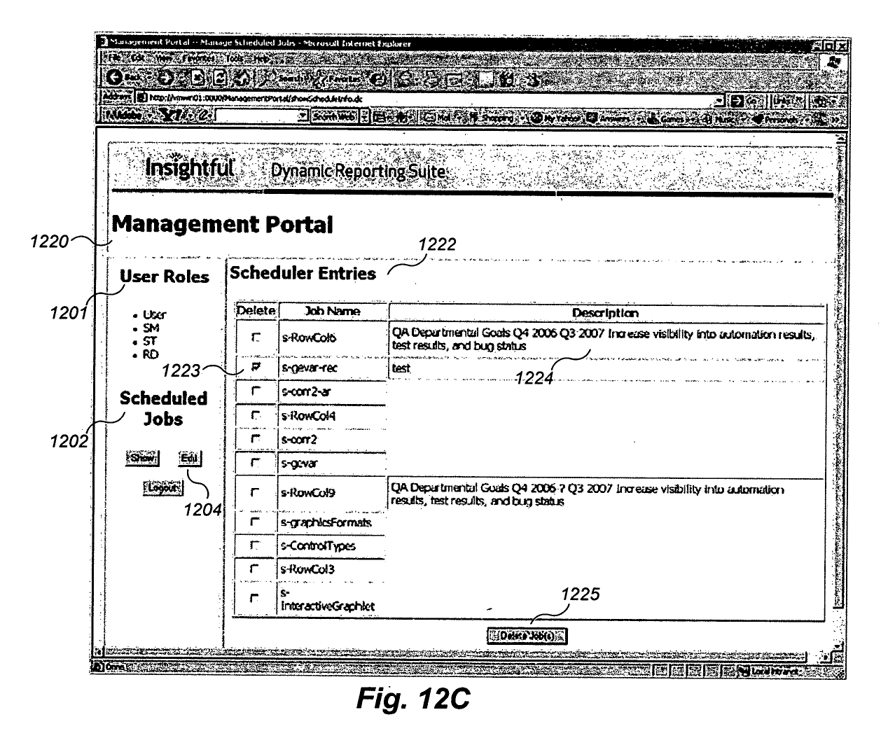

As mentioned above, reports may be scheduled for deferred processing. FIGS. 12A-12C are example screen displays of a user interface for a client web portal for managing the scheduling of reports. In this example, an access permission protocol is also available to constrain access to both reports and the results. In FIG. 12A, the user has selected the management portal page 1200 of the Insightful® Dynamic Reporting Suite (“IDRS”). User roles 1201 corresponding to access permissions and a grouping mechanism can be defined and managed. Further, by selection of one of buttons 1203-1204, any “jobs” (e.g., reports) scheduled for deferred action can be viewed and/or edited. In particular, when a user selects the 1203 button to show scheduled jobs, the page shown in FIG. 12B is displayed. In this view, all of the scheduler information 1203 is available. For each scheduled job, the interface displays a job name 1211, a description 1212, a summary of the analytic name and parameters 1213, constraints 1214 for collections processed by the analytic, an indication of a corresponding template 1215 (if the job originates from a report that is based upon a template), and a status field to obtain information on whether the report has been run. If so, then report link 1217 can be traversed to access the report results.

In FIG. 12C, the user has selected the edit 1221 button and a display web page 1220 showing scheduled job entries 1222 can be seen. Each job entry has an associated delete marking field 1223 and an editable description 1224. Entries are deleted by pressing the delete job(s) button 1225 which deletes all marked entries. Other fields are of course possible.

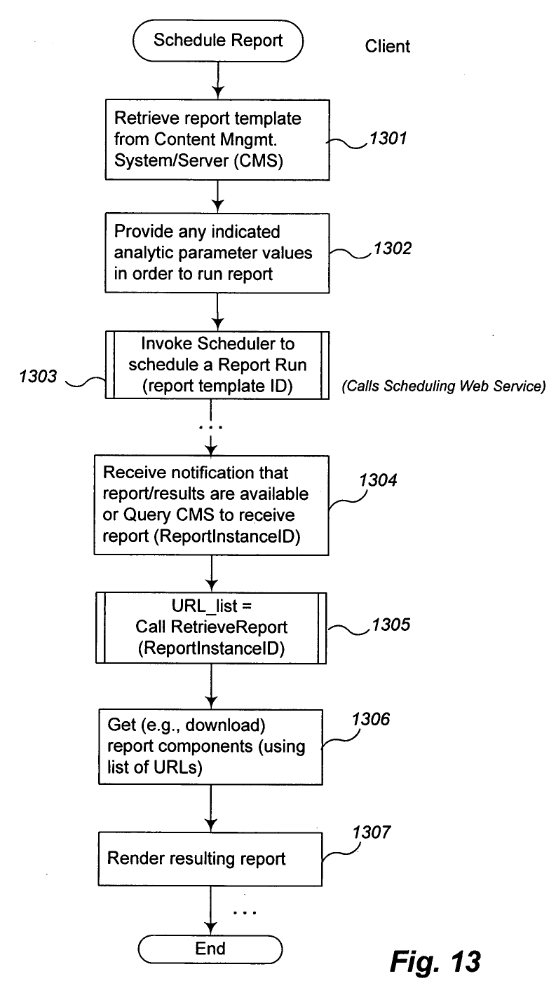

FIG. 13 is an example flow diagram illustrating an example process for scheduling a report to be run by an example Analytics Server Computing System. This routine may be invoked, for example, in response to user selection of the scheduling of a job using the interface shown in FIG. 12. In step 1301, the client module retrieves a report template from storage, such as from a content management system. Using a CMS is beneficial because a consumer can use the search and filtering capabilities of the CMS to locate the desired report template more easily. In step 1302 the client module indicates values for parameters requiring values in order to run the report. These values are typically provided by a user selecting them from a list of possible values, or typing them in. In step 1303, the client module invokes the scheduler to schedule a report run using an identifier associated with the selected report template. This action typically results in a communication with the scheduling web service to define a scheduled event for running the report. In step 1304, the client module (asynchronously) receives notification that the report and/or results are available or queries the result service/CMS directly to ascertain the availability of a report identified by the report template identifier. In step 1305, the client module calls a server, for example, a reporting server, to retrieve the report (e.g., report components) identified by the retrieved report identifier. In one embodiment, the reporting server returns a list of URLs. In step 1306 the client module obtains the results, for example by performing an HTTP “Get” operation to retrieve the report components using one or more URLs obtained in step 1305, which returns links to the report components/data or the report components themselves. These components may be stored, for example, in a results data repository managed by a CMS. In step 1307, the client module renders the resulting report components, resolving any links if present, performs other processing as needed, and ends.

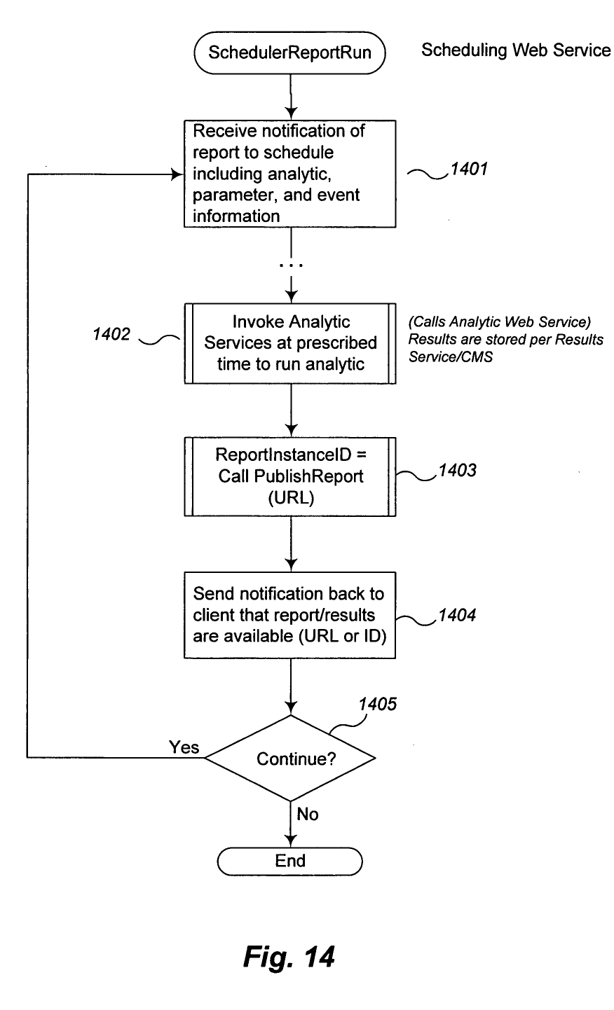

FIG. 14 is an example flow diagram illustrating example interactions performed by an example scheduling web service of an example Analytics Server Computing System to schedule a report. These interactions may occur as a result of a client module scheduling a report per FIG. 13. Of note, the interactions for scheduling a report are similar to some of the steps in FIG. 4, which described communications and actions for scheduled analytic runs. In step 1401, the scheduling web service (“SWS”) receives notification from a client (for example, a reporting client) of a report job to schedule, which includes an analytic, parameters, and event information such as when to trigger the report event. After other (potentially unrelated) processing for handling reports, in step 1402, the SWS invokes one or more analytic web services to run analytics contained in the schedule report job. In step 1403, the SWS communicates with the reporting service/CMS to publish the (executed) report. It passes the reporting service the URL returned from running the report, and keeps an identifier reference to the published report. In step 1404, the SWS sends a notification back to the requesting client that the report results are available (e.g., using a URL or other identifier). (See corresponding step 1304.) The routine then determines in step 1405 whether it has other processing to perform, and, if so, continues in step 1401, else ends.

Some embodiments of an example Analytics Server Computing System provide a user with the ability to run “chained” analytics. For example, a report template designer for a stock reporting service might define a report that calls the same analytic over and over to capture variances in the data over time. Or, for example, a series of analytics, where one or more are different, may be used to perform a specified sequence of different statistical functions on a set of data. Alternately, the same analytic may be chained and run with different parameter values to see a series of different outputs using the same basic underlying analytic. Many variations and other uses of chaining analytics are also possible.

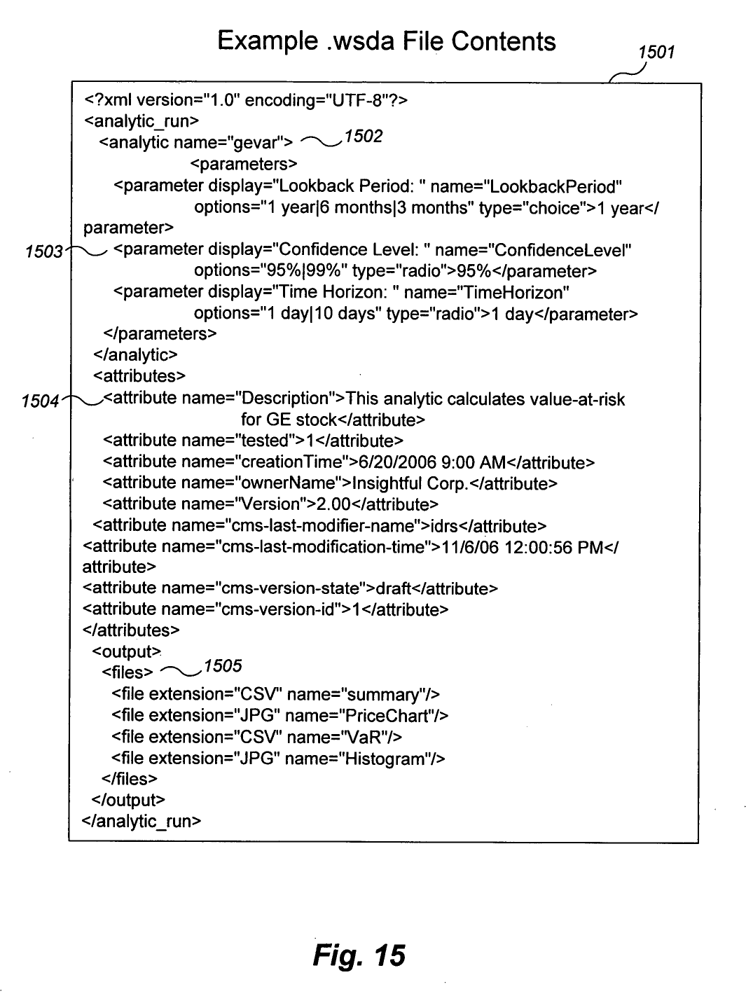

The ASCS is configured to automatically perform a chain of analytics by emitting the input parameters for the next downstream analytic as part of the output of the current analytic. This is made possible because the input to an analytic is specified in a language independent form as a “.wsda” file—which contains XML tag statements understood by the analytic web server. For chained analytics, the parameters for a downstream analytic are specified in an input specification that resembles a .wsda file. FIG. 15 illustrates the contents of an example “.wsda” file. The .wsda file 1501 contains the name of the analytic 1502; a description of the information 1503 that can be displayed for each parameter value; a description of each parameter (attribute) 1504; and a list of the output files 1505 that are created when the analytic is run. Other metadata can be incorporated as needed.

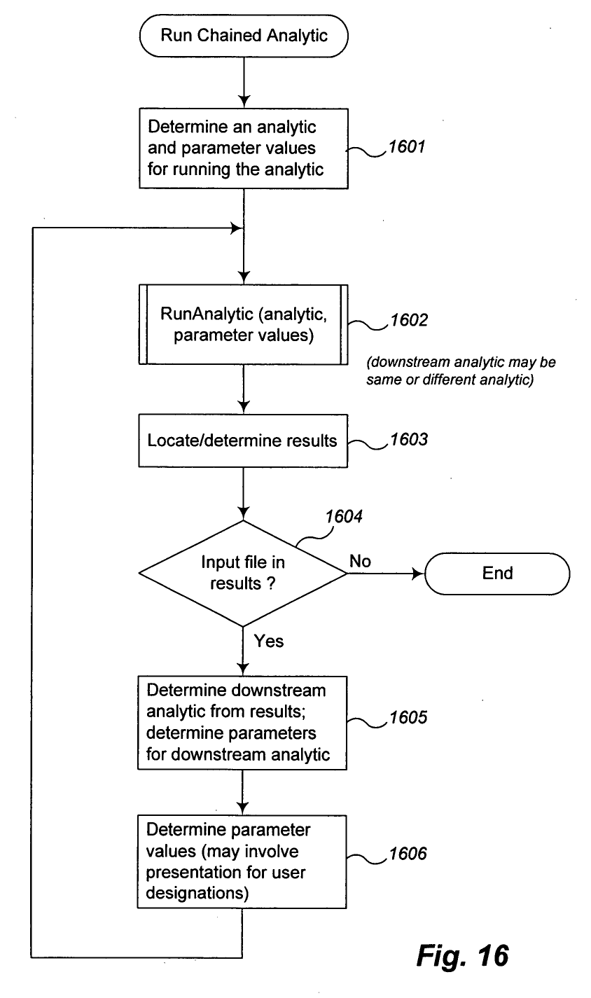

FIG. 16 is an example flow diagram of an example process for running a chained analytic using an example Analytics Server Computing System. This process may be performed, for example, by an analytic web server of the ASCS. In step 1601, the module determines an analytic (the first one) and parameter values for running the analytic from a .wsda file associated with the determined analytic. The .wsda file is determined as part of the activities associated with determining/locating the designated analytic. (See, for example, FIG. 6). The module then performs a loop in steps 1602-1606 for each downstream analytic, until a termination condition is reached. One possible termination condition is that no further input specifications are generated, signaling that there are no more downstream analytics to run. Other termination conditions, such as checking a flag, are also possible.

Specifically, in step 1602, the module causes a RunAnalytic communication to occur, with the determined analytic and associated parameter values. In further iterations of this loop, the determined analytic is a downstream analytic, and may be the same analytic or a different analytic and may have the same parameter values, or different parameters or parameter values. In step 1603, the module locates the results (which may be placed in an directory following predetermined naming conventions) and in step 1604 determines whether an input file, or other input specification, is present in the output results for the currently run analytic. If so, then the loop continues in step 1605, otherwise the chained analytic terminates. In step 1605, the module determines the next downstream analytic in the chain from the input specification present in the output results, and determines any parameters needed to run this next downstream analytic. If these parameters require user selection or input, then in step 1606, the module may communicate sufficient information to the client code to present such a choice. Then, when a selection is communicated back to the module, the module will in step 1606 determine the parameter values for the next run and return to step 1602 to run the next downstream analytic. The client code may, for example, populate a dropdown menu with the input parameter choices for the next downstream analytic.

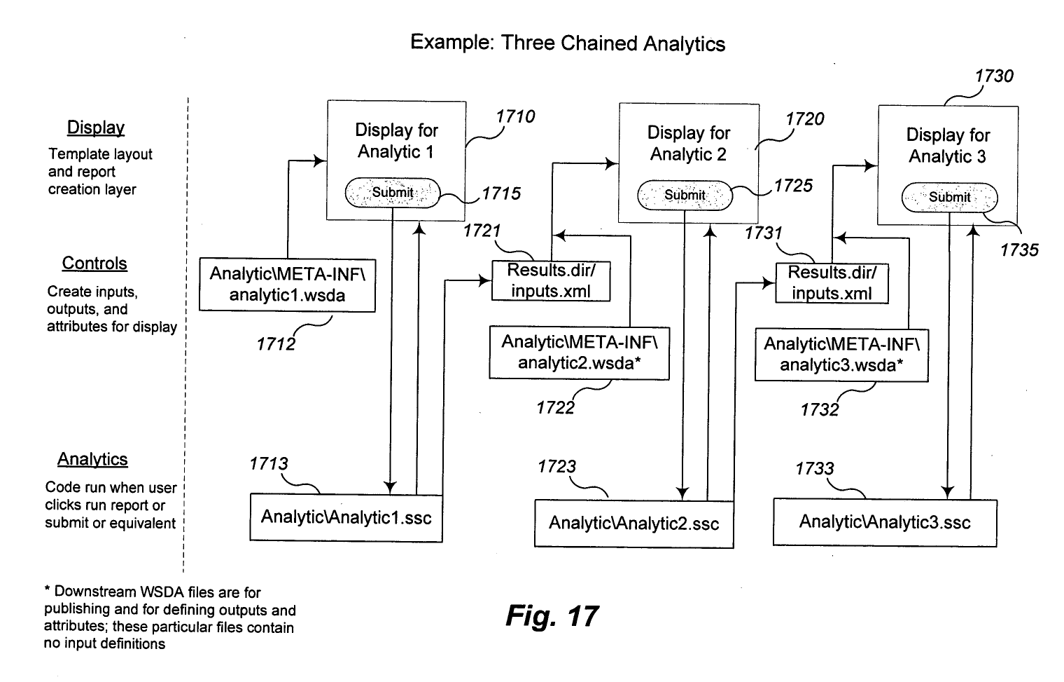

FIG. 17 is an block diagram illustrating the generation and use of example inputs and outputs for chaining three analytics. In this example, the client code (not shown) displays a first analytic presentation 1710, which is run to present a second (downstream) analytic presentation 1720, which is run to present a third (downstream) analytic presentation 1730. A .wsda file 1712 is used to initially present the parameters to a user for selection of the parameter values for the first analytic that corresponds to analytic presentation 1710. When the user presses a submit button 1715 (or equivalent user interface control), the analytic code 1713 corresponding to analytic presentation 1710 is run. In this example, the analytic code 1713 is an S_PLUS script “Analytic1.ssc.” The results of this analytic are displayed as part of the first analytic presentation 1710. The control for the user interface display (may also be part of a service) then determines if an input specification, here shown as Results.dir/inputs.xml file 1721, is present in the results directory. If so, then this xml specification is used as input parameters to the next analytic in the chain. If the input parameters require value selections, then they are displayed for choice selection as part of the second analytic presentation 1720. Note that the .wsda file for the downstream analytic is also used for other analytic information, but the input for the downstream analytic run is not determined from this .wsda file, but rather from the inputs.xml specification. When the user presses a submit button 1725 (or equivalent user interface control), the analytic code 1723 corresponding to analytic presentation 1720 is run, as described with reference to analytic code 1713. The entire process then continues similar for the third analytic presentation 1730. The chained analytic determines in this example after presentation 1730, because no further input specifications are generated.

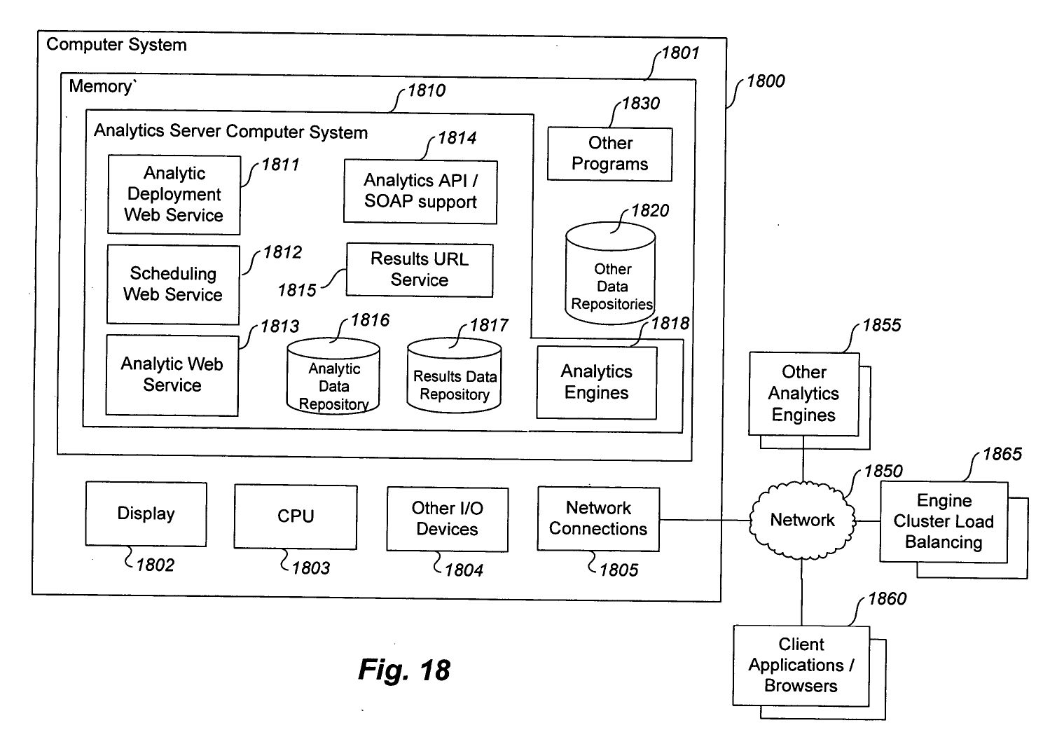

An example Analytic Server Computing System may be implemented using a variety of known and/or proprietary components. FIG. 18 is an example block diagram of a general purpose computer system for practicing embodiments of an Analytics Server Computing System. Note that a general purpose or special purpose computing system may be used to implement an ASCS. The computer system 1800 may comprise one or more server and/or client computing systems and may span distributed locations. In addition, each block shown, including the web services and other services, may represent one or more such blocks as appropriate to a specific embodiment or may be combined with other blocks. Moreover, the various blocks of the Analytics Server Computing System 1810 may physically reside on one or more machines, which use standard (e.g., TCP/IP) or proprietary interprocess communication mechanisms to communicate with each other.

In the embodiment shown, computer system 1800 comprises a computer memory (“memory”) 1801, a display 1802, a Central Processing Unit (“CPU”) 1803, and Input/Output devices 1804 (e.g., keyboard, mouse, CRT or LCD display, etc.), and network connections 1805. The Analytics Server Computing System (“ASCS”) 1810 is shown residing in memory 1801. The components (modules) of the ASCS 1810 preferably execute on one or more CPUs 1803 and manage the generation, publication, sharing, and use of analytics, as described in previous figures. Other downloaded code or programs 1830 and potentially other data repositories, such as data repository 1820, also reside in the memory 1810, and preferably execute on one or more CPUs 1803. In a typical embodiment, the ASCS 1810 includes one or more services, such as analytic deployment web service 1811, scheduling web service 1812, analytic web service 1813, analytics engines 1818, results URL service 1815, one or more data repositories, such as analytic data repository 1816 and results data repository 1817, and other components such as the analytics API and SOAP message support 1814. The ASCS may interact with other analytic engines 1855, load balancing (e.g., analytic engine clustering) support 1865, and client applications, browsers, etc. 1860 via a network 1850 as described below. In addition, the components/modules may be integrated with other existing servers/services such as a content management system (not shown).

In an example embodiment, components/modules of the ASCS 1810 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk), functional (e.g., ML, Lisp, Scheme, etc.), procedural (e.g., C, Pascal, Ada, Modula), scripting (e.g., Perl, Ruby, Python, etc.), etc.

The embodiments described above use well-known or proprietary synchronous or asynchronous client-sever computing techniques. However, the various components may be implemented more monolithic programming techniques as well, for example, an executable running on a single CPU computer system, or alternately decomposed using a variety of structuring techniques known in the art, including but not limited to, multiprogramming, multithreading, client-server, or peer-to-peer, running on one or more computer systems each having one or more any of CPUs. Many are illustrated as executing concurrently and asynchronously and communicating using message passing techniques. Equivalent synchronous embodiments are also supported by an ASCS implementation.

In addition, programming interfaces to the data stored as part of the ASCS 1810 (e.g., in the data repositories 1816 and 1817) can be made available by standard means such as through C, C++, C#, and Java APIs; libraries for accessing files, databases, or other data repositories; through scripting languages such as XML; or through Web servers, FTP servers, or other types of servers providing access to stored data. The analytic data repository 1816 and the results data repository 1817 may be implemented as one or more database systems, file systems, or any other method known in the art for storing such information, or any combination of the above, including implementation using distributed computing techniques. In addition, many of the components may be implemented as stored procedures, or methods attached to analytic or results “objects,” although other techniques are equally effective.

Also the example ASCS 1810 may be implemented in a distributed environment that is comprised of multiple, even heterogeneous, computer systems and networks. For example, in one embodiment, the analytic web service 1811, the analytics engines 1818, the scheduling web service 1812, and the results data repository 1817 may be all located in physically different computer systems. In another embodiment, various components of the ASCS 1810 may be hosted each on a separate server machine and may be remotely located from the tables which are stored in the data repositories 1816 and 1817. Also, one or more of the components may themselves be distributed, pooled or otherwise grouped, such as for load balancing, reliability or security reasons. Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.). Other variations are possible. Also, other functionality could be provided by each component/module, or existing functionality could be distributed amongst the components/modules in different ways, yet still achieve the functions of an ASCS.

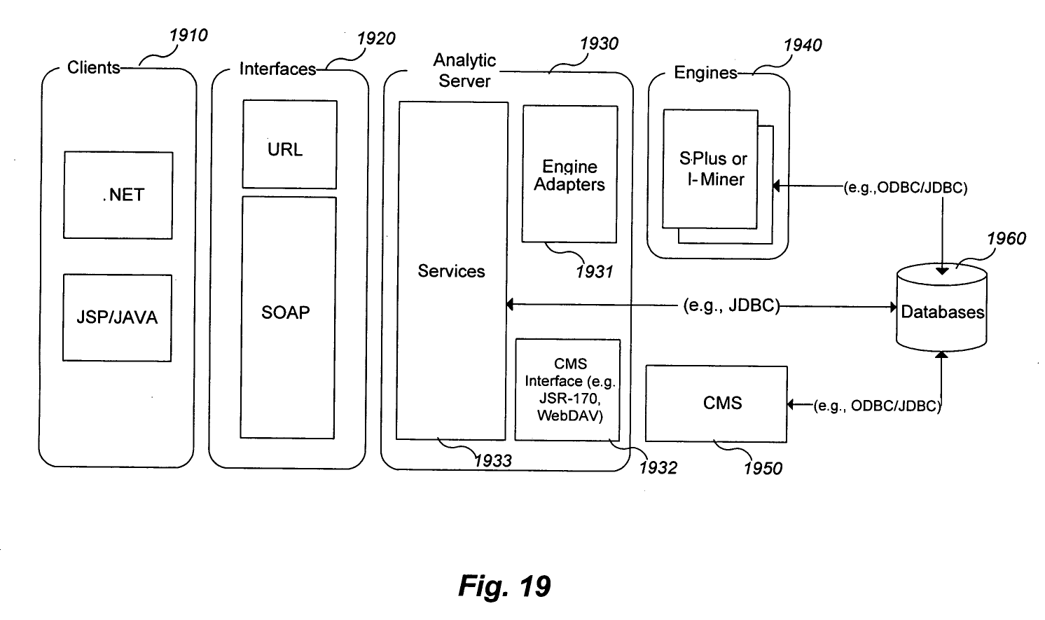

FIG. 19 is an example block diagram of example technologies that may be used by components of an example Analytics Server Computing System to deploy analytics in a client-server environment. This diagram is similar to those depicted by FIGS. 1 and 2, but presents some of the possible technologies that may be used to implement the components. As well, some of the modules, for example the engines 1940 are shown “outside” of the analytic server 1930, but it is understand that they may co-reside with the other modules. Two example technologies, .NET and JSP/JAVA are shown used to implement ASCS clients 1910. These clients communicate to the services of the ASCS typically using the URL and SOAP interfaces 1920. The interfaces 1920 then call the appropriate services with analytic service 1930, for example using Java function calls. One or more engine adapters 1931 are provided to interface to the different types of engines 1940. For example, a separate adaptor for each statistical language may be provided. The engines 1940 typically communicate with the relevant data repositories 1960 using ODBC or JDBC protocols, however, other protocols may be used. In a current implementation, the analytic web services 1933 are implemented in Java, and thus communicate with the data repositories 1960 using JDBC. Also, in some deployments of the ASCS, a CMS 1950 such as Daisy is integrated as the results service for obtaining the results of running analytics. Different CMS interfaces 1932 are correspondingly implemented in the analytic server 1930 to communicate with the CMSes.

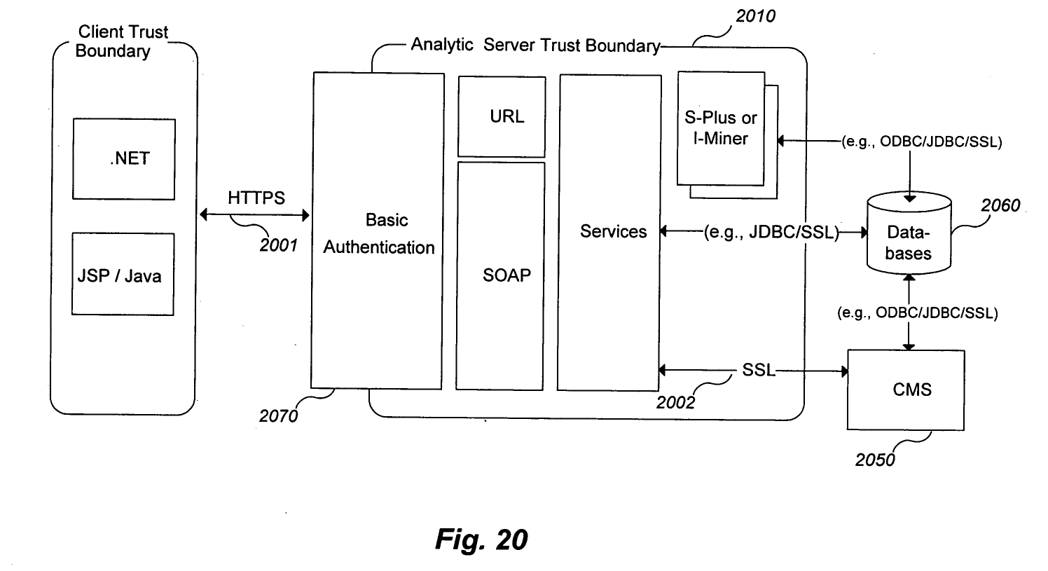

As mentioned, it is possible to deploy the ASCS in a secure server type of environment using known or proprietary security and authentication mechanisms. FIG. 20 is a block diagram of an example configuration of components of an example Analytics Server Computing System to implement a secure client-server environment for deploying and using analytics. Similar components to those in FIG. 19 are depicted. In a secure environment, all of the interfaces to the analytic web services and their interfaces to outside (third party) data repositories 2060 and CMSes 2050 are made accessible only through secure protocols such, as HTTPS 2001 and using SSL 2002. An authentication service 2070 is also provided to make sure each access is to a service or data is authorized. Other technologies and mechanisms for providing security can be similarly incorporated.

Several paradigms and integration mechanisms are available for application integrators either to build tailored user interfaces or to incorporate the ASCS services into a broader service oriented platform. As mentioned earlier, analytics may be dynamically discovered and then a designated analytic run, or a specific analytic run may be requested. The dynamically discoverable analytics mechanism is particularly useful in environments where analytics are numerous and subject to change. Usage requires an initial step of discovering what analytics exist as well as how to call them (e.g., their signatures, parameters, etc.). This very dynamic interface tends to makes client user interfaces more complex as well as complicate the task of integrating analytics in the context of other systems. However, it provides a highly dynamic and flexible mechanism and is particularly suitable for quickly evolving situations. The functional analytics mechanism for running analytics is particularly useful in environments where the analytics are few and their names and parameters are quite stable. This mechanism enables analytics at the functional level to be directly incorporated in client code, where the analytics are exposed as functions with well defined parameters. Such an approach is suitable, for example, in a “one button” scenario where the user interface can be hard coded to reflect unchanging external demands of the analytic. Exposing the analytics interfaces explicitly also typically permits building services workflows more comprehensively than is possible with dynamically discoverable analytics.

The dynamically discoverable analytics mechanism and the functional analytics mechanism may be used each alone or in combination with each other. These mechanism can be further performed either using message protocols directly (such as by calling the corresponding ASCS defined SOAP messages, e.g., GetAnalyticInfo using appropriate XML) or using API, defined and exposed by the ASCS. In one embodiment the ASCS provides three types of API integration points. A URL API provides an ability to interface to web pages for invoking an analytic web service. For example a customer designed button could lead to a parameter page for a particular analytic. A JavaScript API provides both a dynamically discoverable analytics mechanism and for the functional analytics mechanism. For example an analytic analysisA that requires a single parameter year would be mapped to a function of the style: analysisA (year). These API can directly translate to SOAP messages which are further transformed to Java (for example, using an XLT file with XSLT processing), which is understood by the analytic web services layer. This technology makes it possible to build clients either in .NET or using some form of Java framework. Additionally, both a URL as well as a JavaScript SDK are provided in order to allow other integration points where relevant for both the .NET and the Java world. A WSDL-generated API provides an ability to interface directly to the SOAP services of the ASCS. Using the WSDL file automatically published by a SOAP service, both Java and .NET environments can be used to automatically build an API that can be used directly to call the ASCS services

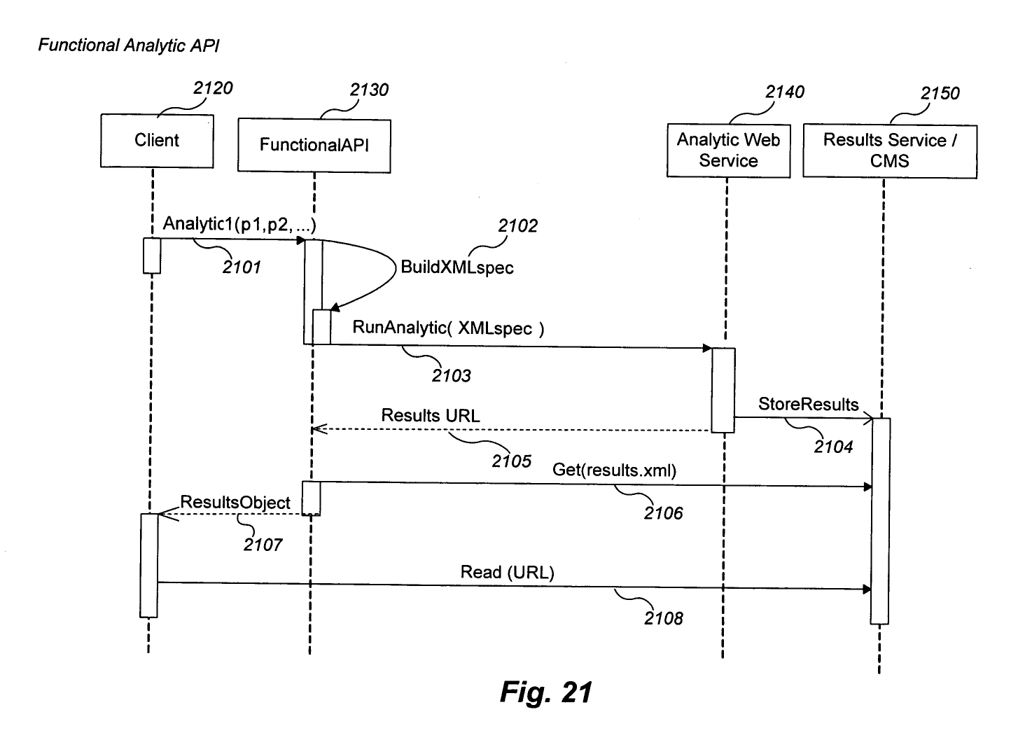

FIG. 21 is an example sequence flow diagram of the interactions performed by example components of an Analytics Server Computing System to provide a function-based programmatic interface to run a designated analytic. The functional analytic API allows a client interface to run a designated analytic using a remote procedure call type of interface. In FIG. 21, client 2120 makes a remote procedure call using the Analytic1(p1, p2, . . . ) communication 2101, wherein “Analytic1” is the designated analytic and “p1” and “p2” are designated parameter values. The API implementation 2130 translates the function call 2101 to an XML specification in event 2102, which can be understood by the messaging (e.g., SOAP) interface. This XML (input) specification is passed as an argument to the RunAnalytic message interface communication 2103. This communication then causes an appropriate analytic web service 2140 to produce result files which are stored via the StoreResults communication 2104 using results service/CMS 2150. As described earlier, these results files are made available to the client 2120 typically via URL references obtained by the API using a Get(results.xml) function call 2106. In the example shown, the API returns an object (e.g., a JavaScript object) 2107 to the client 2120 so the client can access the result files as desired.

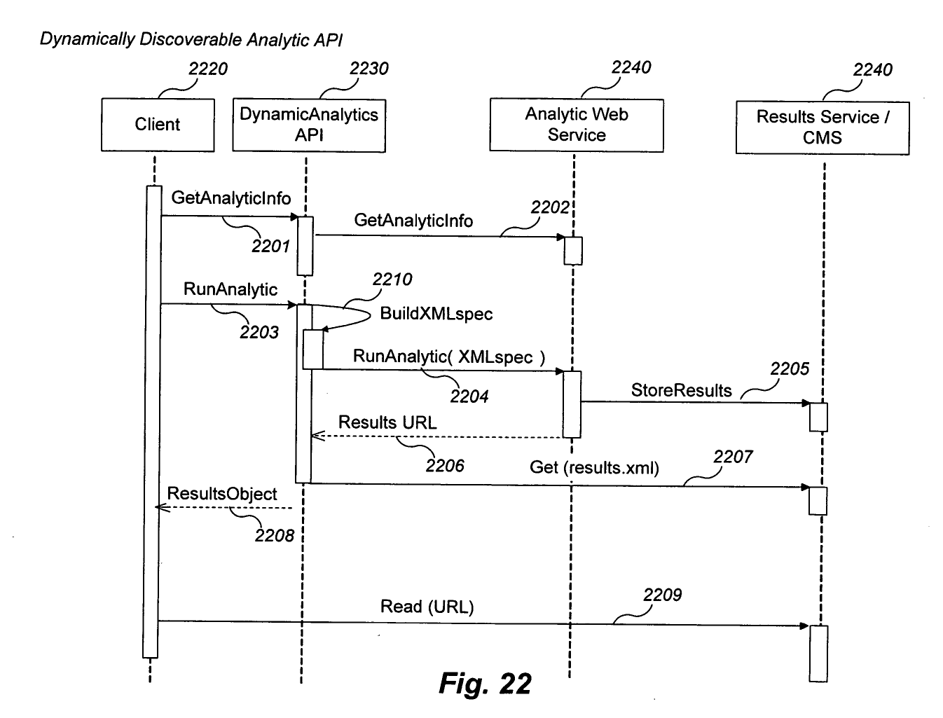

FIG. 22 is an example sequence flow diagram of the interactions performed by example components of an Analytics Server Computing System to provide a programmatic interface to dynamically discover and then run a designated analytic. The dynamically discoverable analytic API allows a client interface to determine which analytics are available using a remote procedure call type of interface, and then to call a designated analytic using an API in a manner similar to that described with reference to FIG. 21. In FIG. 22, the client 2220 makes a remote procedure call using the GetAnalyticInfo communication 2201, which results in a GetAnalyticinfo message interface communication 2202 (e.g., a SOAP message) which is processed by an analytic web service 2240 to find and send back an indication of all of the available analytics, typically as an XML specification. Then, once an analytic is selected to be run, communications 2203-2208 are processed similarly to communications 2101-2108 described with reference to FIG. 21. When the results of running the analytic are available, they can be obtained as desired by client 2220 from the results service/CMS 2250.

In one embodiment, several different SOAP services may be defined to support the functional analytic API and dynamically discoverable analytic API illustrated in FIGS. 21 and 22. For example, a “getAnalyticNames( )” service may be defined to obtain a list of all of the analytics available to be run. Once an analytic is designated, the “getAnalyticInfo(name)” service may be called to retrieve the appropriate (analytic developer supplied) meta-data, which is then used to generate the appropriate parameter values. Once the inputs are defined, the “runAnalytic(specification8tring)” service may be invoked to cause an analytic web service to run the analytic as specified in “specification8tring” by invoking an analytics engine (e.g., an S-PLUS interpreter) with the “specification8tring”.

All of the above U.S. patents, U.S. patent application publications, U.S. patent applications, foreign patents, foreign patent applications and non-patent publications referred to in this specification and/or listed in the Application Data Sheet, including but not limited to U.S. Provisional Patent Application No. 60/789,239, entitled “SERVICE-ORIENTED ARCHITECTURE FOR REPORTING AND SHARING ANALYTICS,” filed Apr. 3, 2006, is incorporated herein by reference, in its entirety.

From the foregoing it will be appreciated that, although specific embodiments have been described herein for purposes of illustration, various modifications may be made without deviating from the spirit and scope of the invention. For example, the methods and systems for performing the formation and use of analytics discussed herein are applicable to other architectures other than a HTTP, XML, and SOAP-based architecture. For example, the ASCS and the various web services can be adapted to work with other scripting languages and communication protocols as they become prevalent. Also, the methods and systems discussed herein are applicable to differing programming languages, protocols, communication media (optical, wireless, cable, etc.) and devices (such as wireless handsets, electronic organizers, personal digital assistants, portable email machines, game machines, pagers, navigation devices such as GPS receivers, etc.).

1. A computer-based method in a server computing system for providing electronic access to a chain of statistical analytics over a network using web-based protocols, comprising:
upon receiving an indication of a first analytic, providing an indication of meta-data that indicates a first set of parameters that can be specified for the indicated first analytic;
causing the indicated first set of parameters to be presented;
upon receiving an indication of values associated with one or more of the indicated first set of parameters, causing the first analytic to be executed with the indicated values associated with the one or more of the indicated first set of parameters by an independently executing analytics engine configured to run the first indicated analytic and produce a first result in an output repository;
providing an indication of the produced first result;
upon determining that an input specification exists as part of the produced result, automatically determining from the input specification an indication of a second analytic and an indication of a second set of parameters that can be specified for the indicated second analytic;
causing the indicated second set of parameters to be presented;
upon receiving an indication of values associated with one or more of the indicated second set of parameters, causing the second analytic to be executed with the indicated values associated with the one or more of the indicated second set of parameters by an independently executing analytics engine configured to run the second indicated analytic and produce a second result in an output repository; and
providing an indication of the produced second result.

2. The method of claim 1 wherein the first analytic and the second analytic are the same analytic, and the access to the chain of statistical analytics provides an ability to rerun the same analytic using different sets of parameter values.

3. The method of claim 1 wherein the first analytic and the second analytic are the same analytic, and the access to the chain of statistical analytics provides an ability to rerun the same analytic using different sets of parameters.

4. The method of claim 1 wherein the first analytic is different than the second analytic and the first analytic is used to provide a choice of input parameters for the second analytic.

5. The method of claim 1 wherein the second analytic is caused to be executed to produce another input specification for another downstream analytic, and the downstream analytic is caused to be run to produce another input specification for a next downstream analytic in an iterative manner until a termination condition is reached.

6. The method of claim 5 wherein the termination condition is that no another input specification is produced.

7. The method of claim 1 wherein the input specification is a file have a “.wsda” file extension.

8. The method of claim 1 wherein the causing the indicated first set of parameters to be presented is performed by sending a response to a message or in response to an API invocation.

9. The method of claim 8 wherein the causing the indicated second set of parameters to be presented is performed by sending a response to a message or in response to an API invocation.

10. The method of claim 1 wherein the web-based protocols are at least one of HTTP or SOAP.

11. The method of claim 1 wherein XML strings are used to indicate the first or second set of parameters.

12. The method of claim 1, further comprising:
automatically storing the produced output result on a searchable content server or a content management system.

13. The method of claim 1 wherein the independently executing analytic engine configured to run the first indicated analytic is different than the independently executing analytic engine configured to run the second indicated analytic.

14. The method of claim 13 wherein the independently executing analytic engine configured to run the first indicated analytic runs an analytic written in S-Plus language.

15. The method of claim 13 wherein the independently executing analytic engines are configured to run analytics written in the same language but hosted on different computing systems.

16. The method of claim 1 wherein each analytic engine is selected according to a load balancing protocol.

17. A reporting computing system configured to provide at least one report that causes the first analytic and the second analytic to be executed to produce the first result and the second result according to the method of claim 1.

18. The reporting system of claim 17 implemented as a reporting server.

19. The reporting system of claim 17 implemented using a web browser.

20. The reporting system of claim 17 wherein the at least one report is scheduled to cause the first analytic to be executed at a determined time.

21. The reporting system of claim 20 wherein the determined time is at least one of a prescribed time, a range of time, or on a periodic basis.

22. The reporting system of claim 17, further comprising controlling execution of both the first analytic and the second analytic using the same user interface control.

23. The reporting system of claim 22 wherein the user interface control presents the first set of parameters in preparation for controlling execution of the first analytic and presents the second set of parameters in preparation for controlling execution of the second analytic using results from execution of the first analytic.

24. A web portal configured to provide an interface to an analytic server that causes the first analytic and the second analytic to be executed to produce the first result and the second result according to the method of claim 1.

25. The web portal of claim 24, further configured to have access to a data repository, and wherein at least one of the analytics provides a statistical analysis of data from the data repository.

26. The web portal of claim 25 wherein the data repository is a corporate data base.

27. The web portal of claim 24, further configured to be scheduled to cause the first analytic to be executed at a determined time.

28. The web portal of claim 24 wherein the determined time is at least one of a prescribed time, a range of time, or on a periodic basis.

29. The web portal of claim 24 wherein the interface is a web browser.

30. A computer-readable medium whose contents enable a server computing system to provide electronic access to a chain of statistical analytics over a network using web-based protocols, by performing a method comprising:
receiving an indication of a first analytic;
running the first analytic to produce a first result output including an analytic run specification file that specifies parameters for running a downstream analytic and an indication of the downstream analytic;
setting the analytic run specification file produced by the first result output as a next analytic run specification file;
setting the indicated downstream analytic as a next downstream analytic; and
using an independently executing analytics engine, automatically running the next downstream analytic using values for the parameters specified by the next analytic run specification file and producing a next result output including a next analytic run specification file that specifies parameters for running an indicated next downstream analytic and repeating the automatically running for each subsequent indicated next downstream analytic and next analytic run specification file until a termination condition occurs.

31. The computer-readable medium of claim 30 wherein the computer-readable medium is at least one of a memory in a computing device or a data transmission medium transmitting a generated signal containing the contents.

32. The computer-readable medium of claim 30 wherein the contents are instructions that, when executed, cause the computing system to perform the method.

33. The computer-readable medium of claim 30 wherein the first analytic and a next downstream analytic are the same analytic.

34. The computer-readable medium of claim 30 wherein the first analytic is different than a next downstream analytic.

35. The computer-readable medium of claim 30 wherein the termination condition is that no next analytic run specification file is produced.

36. The computer-readable medium of claim 30 whose contents are executed responsive to a request from a reporting server or a web portal.

37. An analytic server computing system comprising:
an analytic repository;
a plurality of statistical engines, each engine configured to execute analytics written in at least one statistical language associated with the engine;
an analytic deployment web service configured to receive an indication of analytic code composed in a statistical language associated with at least one of the statistical engines and a description of parameters necessary to run the analytic code, and configured to automatically store in the analytic repository the indicated analytic code along with configuration information necessary to discover and execute the indicated analytic;
an analytic web service configured to
interface to one or more of the statistical engines,
receive an indication of a designated analytic and a set of values corresponding to one or more parameters associated with the designated analytic,
cause retrieval of the analytic code that corresponds to the designated analytic from the analytic repository, and
cause execution, by a determined one of the one or more statistical engines, of the retrieved analytic code using the received set of parameter values; and
a scheduling web service configured to forward an indication of a designated analytic and the set of associated parameter values to cause the analytic web service to cause execution of the analytic code that corresponds to the designated analytic on a determined schedule.

38. The analytic server computing system of claim 37, further comprising:
a results data repository configured to receive and store result data from executed analytic code;
a results service configured to receive an indication of an executed analytic for which results are desired and retrieve from the results data repository result data corresponding to the indicated executed analytic.

39. The analytic server computing system of claim 38 wherein the indication of the executed analytic for which results are desired is performed by resolving a uniform resource locator (URL or URI).

40. The analytic server computing system of claim 39 wherein the results service is provided by or in conjunction with a content management system.

41. The analytic server computing system of claim 39 wherein the results service is provided by a content management server that provides search capabilities and a security scheme for accessing results data.

42. The analytic server computing system of claim 37 wherein the determined schedule is one of a prescribed time, a prescribed calendar event, a range of time, or a periodic basis.

43. The analytic server computing system of claim 37 wherein the scheduling web service is a scheduling service provided by a provider distinct from the provider of the analytic server computing system.

44. The analytic server computing system of claim 37 wherein the analytic web service is further configured to provide an indication of published analytics in response to a request.

45. The analytic server computing system of claim 37 wherein the analytic web service is further configured to determine a set of specifiable parameters for a designated analytic using meta-data associated with the analytic and to provide an indication of the determined set in response to a request.

46. The analytic server computing system of claim 37 wherein the indication of the designated analytic and the set of values corresponding to one or more parameters associated with the designated analytic is received using a message based network communication.

47. The analytic server computing system of claim 46 wherein the message-based network communication uses a SOAP-based messaging protocol.

48. The analytic server computing system of claim 37, the analytic web service further configured to first determine one of the one or more statistical engines to use to execute the retrieved analytic code based upon a load balancing mechanism that selects a statistical engine from among the one or more statistical engines capable of executing the retrieved analytic code.

49. The analytic server computing system of claim 37 wherein the analytic web server is further configured to cause retrieval of the analytic code that corresponds to the designated analytic only when security characteristics associated with the designated analytic indicate authorization.

50. The analytic server computing system of claim 37 wherein the plurality of statistical engines include an engine configured to run programs written in at least of S-Plus, R, SAS, Matlab, SPSS, or Mathematica.

51. The analytic server computing system of claim 37 wherein the plurality of statistical engines include an engine configured to run programs written S-Plus.
